(19) United States
(12) Patent Application Publication
(10) Pub. No.: US 2007/0245176 A1
(43) Pub. Date: Oct. 18, 2007

(54) BER monitoring circuit

(75) Inventors: Shinji Sawane, Kawasaki (JP); Yuji Obana, Kawasaki (JP); Hiroyuki Kitajima, Kawasaki (JP)

Correspondence Address: BINGHAM MCCUTCHEN LLP, 2020 K Street, N.W., Intellectual Property Department, WASHINGTON, DC, 20006, US

(73) Assignee: Fujitsu Limited

(21) Appl. No.: 11/502,517

(22) Filed: Aug. 11, 2006

(30) Foreign Application Priority Data
Mar. 24, 2006 (JP) 2006-082904

(51) Int. Cl. G06F 11/00

(52) U.S. Cl. 714/704

(57) ABSTRACT

In a BER monitoring circuit, error cycles of input data are detected by a parity check portion and an error cycle detecting portion, a maximum (average/median) value is detected from among the error cycles by an error cycle memory and an error cycle maximum (average/median) value retrieving portion. The value is converted into a corresponding estimated error rate by a Tₑ-BER conversion table and an alarm is generated by an SF/SD detecting -portion when the estimated error rate exceeds an alarm detecting threshold. Thereafter, the alarm is released when the estimated error rate assumes equal to or less than an alarm releasing threshold. Also, an error-free detecting portion is activated when an alarm is generated and releases the alarm when a time period for which the error cycles stay flat exceeds a cycle corresponding to the alarm releasing threshold.

### BACKGROUND OF THE INVENTION

1. Field of the Invention

The present invention relates to a BER (Bit Error Rate) monitoring circuit and method, and in particular to a circuit and method for monitoring a BER of input data in a transmission apparatus or the like.

2. Description of the Related Art

In order to guarantee the validity of transmitted/received data in a network, a parity byte is defined in a format of a transmission signal, and a BER monitoring circuit for confirming the data is used.

FIG. 7 shows a prior art example of such a BER monitoring circuit.

In this BER monitoring circuit, input data undergoes a parity check at a parity check portion 11, so that an error pulse is generated. The parity check portion 11 performs the parity check based on a result of a parity calculation for a BIP-8 calculation field (see FIG. 8B) stored in an ODUK overhead field of FIG. 8A in a signal frame format of an OTU shown in FIGS. 8A and 8B.

The error pulse of the parity check portion 11 is transmitted to a counting portion 12. The counting portion 12 counts how many error pulses are generated while timer signals are generated from a timer 13 operated by a clock, and transmits the counted value to a comparing portion 14. The comparing portion 14 compares a set value V_{O} with the counted value, that is the number of error pulses from the counting portion 12, and generates an SF-SD (Signal Failure/Signal Degrade) alarm when the number of error pulses exceeds the set value V_{O}.

It is to be noted that the following patent documents 1 and 2 can be mentioned as a general conventional technology of such a circuit monitoring the BER.

The patent document 1 discloses a system that measures an error rate with a simplified error rate measuring system of a simplified arrangement. The system is composed of means extracting frame synchronizing pulses of plurality of channels, a detection means detecting an error pulse by a majority decision mutually between the frame synchronizing pulses extracted by the extraction means, and a count means counting the error pulse detected by the detection means, so that the count means counts the error pulses of the frame synchronizing pulses to measure the error rate.

In the patent document 2, an RF receiving portion outputs a RSSI signal indicating strength of a received signal, a unique word detecting portion outputs a UW signal indicating synchronization/asynchronization of a digital signal, and an error correcting portion outputs a bit B signal every time a bit is taken in and outputs a BE signal indicating an error bit every time the error bit is detected. The B signal and the BE signal are counted by a time T counter set up in a measurement time setting circuit, so that the counted values are divided by a divider circuit and a BER signal indicating the error rate is obtained. A decision circuit controls a muting circuit so that a muting operation is not performed when the RSSI signal is equal to or above a reference level RF_{RSSI}, the UW signal indicates a synchronization, and the BER signal is equal to or below a reference level RF_{BER}.

[Patent document 1] Japanese patent application laid-open No.60-256239

[Patent document 2] Japanese patent application laid-open No.2000-216757

In the prior art BER monitoring circuit shown in FIG. 7, the number of error pulses within the reference time by the timer is counted and an alarm is generated as indicating an SF or SD state when the number has reached a threshold. In this prior art, a reference time is set based on a maximum time rule defined for an SF/SD detection, so that there is a problem that the SF/SD detecting/releasing system cannot be applied in the absence of the timer rule.

Also, due to the presence of the monitoring timer, there is a problem that a minimum time corresponding to a cycle of the timer is required for the SF/SD detecting/releasing operation.

### SUMMARY OF THE INVENTION

It is accordingly an object of the present invention to provide a circuit and method capable of monitoring a BER without using a timer.

In order to achieve the above-mentioned object, a BER monitoring circuit according to one aspect of the present invention comprises: a first means detecting error cycles of input data; a second means detecting a maximum value from among the error cycles; a third means converting the maximum value into a corresponding estimated error rate; and a fourth means generating an alarm when the estimated error rate exceeds an alarm detecting threshold.

Namely, in the above-mentioned aspect of the present invention, the first means detects error circles (e.g. number of frames) of input data, and the second means detects a maximum value from among the error cycles detected by the first means. The third means converts the maximum value into a corresponding estimated error rate. The fourth means generates an alarm when the error rate estimated by the third means exceeds a preset alarm detecting threshold.

Thus, without using a timer, intervals of bit error occurrences are monitored, and a BER is estimated by obtaining a maximum value within a certain time period, whereby an alarm is generated. “Within a certain time period” herein indicates a time period for collecting a plurality of error cycles, and is calculated as a time period that meets a detection probability of the SF/SD. Since this certain time period is not a fixed time period by a timer, waiting for a fixed time upon an alarm detection becomes unnecessary.

The above-mentioned fourth means may include means releasing the alarm when the estimated error rate assumes equal to or less than an alarm releasing threshold.

Namely, the alarm can be released when the estimated error rate assumes equal to or less than an alarm releasing threshold after the alarm has been generated as mentioned above. Also in this case it becomes unnecessary to wait for a fixed releasing time period by the timer.

Also, the BER monitoring circuit may further comprise a fifth means being activated when the alarm is generated and releasing the alarm when a time period for which the error cycles stay flat exceeds a cycle corresponding to the alarm releasing threshold.

Namely, since an error pulse is not generated if no error occurs in the input data, the alarm release cannot be performed even in an alarm releasing state. Accordingly, the fifth means enables a release of the alarm when a time period for which the error cycles stay flat exceeds a time period corresponding to the alarm releasing threshold.

Moreover, the BER monitoring circuit may further comprise a sixth means constantly calculating a deviation of the error cycles and generating a burst flag when the deviation upon generation of the alarm exceeds a burst detecting threshold.

Thus, it becomes possible to determine whether or not the present alarm detected state is due to a concentrated error occurrence.

The third means may substitute an average (mean value) or a median for the maximum value.

Thus, an influence of a burst-like error occurrence can be reduced.

As described above, an alarm detection of the BER can be performed only from a perspective of a detecting probability/releasing probability according to the present invention. Since a timer-based circuit arrangement is not adopted, there is an effect that a detecting and a releasing time is reduced compared with the prior art.

Also, when the function is realized on the premise of scattered bit error occurrence, a concentrated error occurrence can be attended with a deviation of the error cycles.

The present invention further provides a BER monitoring circuit comprising: a first detector detecting error cycles of input data; a second detector detecting at least one of a maximum value, an average value, and a median value from among the error cycles; a converter converting the value into a corresponding estimated error rate; and a generator generating an alarm when the estimated error rate exceeds an alarm detecting threshold.

The present invention further provides a BER monitoring method comprising: a first step of detecting error cycles of input data; a second step of detecting at least one of a maximum value, an average value, and a median value from among the error cycles; a third step of converting the value into a corresponding estimated error rate; and a fourth step of generating an alarm when the estimated error rate exceeds an alarm detecting threshold.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment [1] of a BER monitoring circuit according to the present invention;

FIG. 2 is a diagram showing an error cycle Tₑ-BER conversion table used in a BER monitoring circuit according to the present invention;

FIG. 3 is a graph showing the Tₑ-BER conversion table shown in FIG. 2;

FIG. 4 is a block diagram showing an embodiment [2] of a BER monitoring circuit according to the present invention;

FIG. 5 is a block diagram showing an embodiment [3] of a BER monitoring circuit according to the present invention;

FIG. 6 is a block diagram showing an embodiment [4] of a BER monitoring circuit according to the present invention;

FIG. 7 is a block diagram showing an example of a prior art BER monitoring circuit; and

FIGS. 8A and 8B are diagrams showing a signal frame format of an OTU used by a parity check portion.

### DESCRIPTION OF THE EMBODIMENTS

Hereinafter, embodiments of a BER monitoring circuit and method according to the present invention will be described referring to the attached figures.

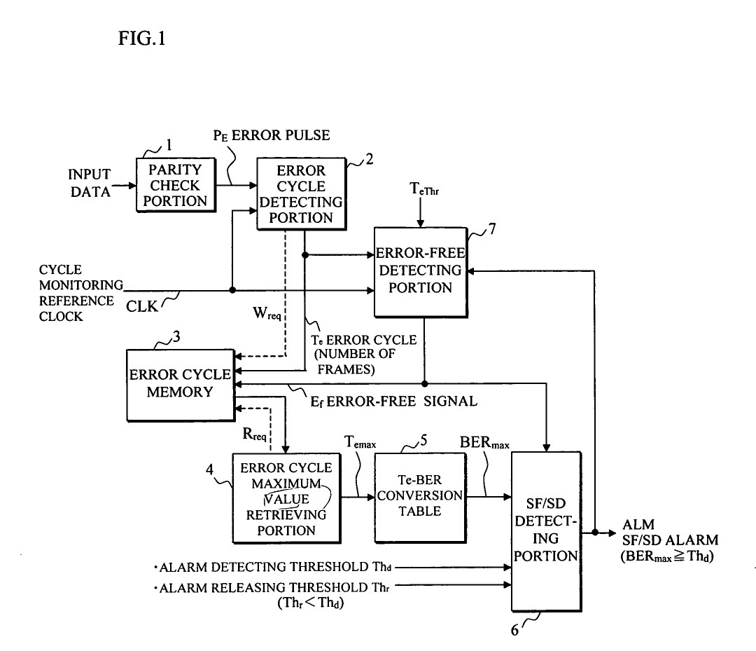

### Embodiment [1]: FIG. 1

FIG. 1 shows an embodiment [1] of a BER monitoring circuit and method according to the present invention. In this embodiment, input data is provided to a parity check portion 1, and an error pulse P_{E} outputted from the parity check portion 1 is transmitted to an error cycle detecting portion 2. A cycle monitoring reference clock CLK is provided to the error cycle detecting portion 2. Error cycles (number of frames) Tₑ that are output signals of the error cycle detecting portion 2 are provided to an error cycle memory 3.

The error cycle memory 3 stores a plurality of the error cycles Tₑ from the error cycle detecting portion 2, and the maximum error cycle Tₑₘₐₓ thereof is detected by an error cycle maximum value retrieving portion 4 connected to the error cycle memory 3. The maximum error cycle Tₑₘₐₓ is transmitted to a Tₑ-BER conversion table 5, converted to an estimated error rate BERₘₐₓ corresponding thereto, and outputted to an SF/SD detecting portion 6.

The SF/SD detecting portion 6 is preliminarily provided with an alarm detecting threshold Th_{d} and an alarm releasing threshold Thᵣ (Thᵣ<Th_{d}), and generates and releases the SF/SD alarm ALM under given conditions.

The alarm ALM is also provided to an error-free detecting portion 7. The error-free detecting portion 7 further receives the error cycles Tₑ from the error cycle detecting portion 2 and the cycle monitoring reference clock CLK, and commonly provides an error-free signal E_{f} to the error cycle memory 3 and the SF/SD detecting portion 6.

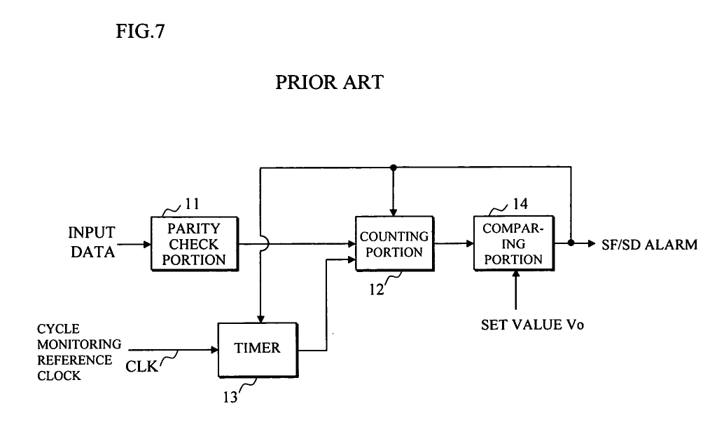

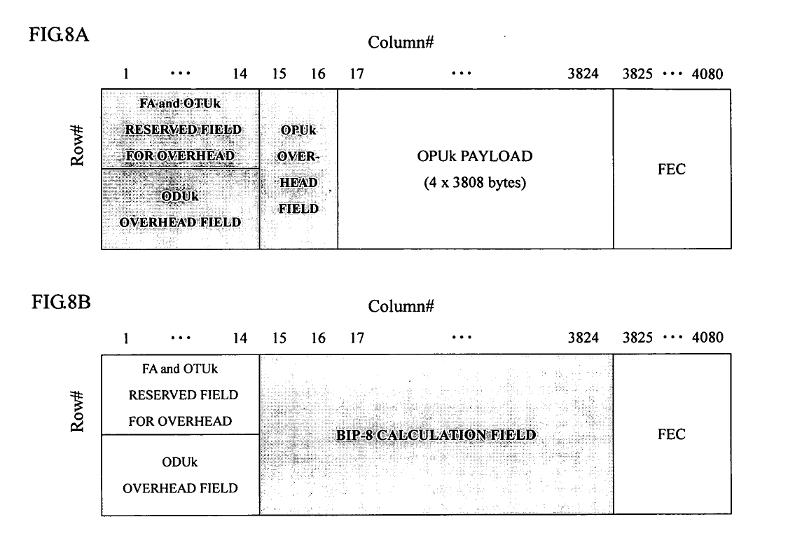

In operation of this BER monitoring circuit, when the input data is provided to the parity check portion 1, the parity check portion 1, in the same way as the prior art example shown in FIG. 7, detects the parity error of the input data based on a parity check result with respect to the BIP-8 calculation field in the signal format of FIGS. 8A and 8B, and provides an error pulse P_{E} to the error cycle detecting portion 2. It is to be noted that when the BIP-8 and the like are processed in parallel, the output of the parity check portion 1 may be made a total of the number of error counts and a latch timing.

In the error cycle detecting portion 2, the cycle monitoring reference clock CLK is used for counting the number of reference clocks from the last inputted error pulse to the present error pulse. The counted value is outputted to the error cycle memory 3 as the error cycle (number of frames) Tₑ of a binary number. At the same time, the error cycle detecting portion 2 outputs a write request pulse W_{req} indicated by a dotted line to the error cycle memory 3. It is to be noted that the cycle monitoring reference clock CLK is synchronized with a parity calculation cycle.

The error cycle memory 3 sequentially stores the error cycle Tₑ upon receiving the write request W_{req} from the error cycle detecting portion 2. In this case, the error cycle memory 3 has a storage capacity for e.g. 80 times in total.

The error cycle maximum value retrieving portion 4 provides a read request R_{req} indicated by a dotted line to the error cycle memory 3 at a constant frequency, for example, to read all of the data within the memory 3, and then selects the maximum value from among all of the error cycles Tₑ read. The maximum value read is transmitted to the conversion table 5 in the form of a binary number Tₑₘₐₓ.

The conversion table 5 outputs a BER estimated value BERₘₐₓ based on and corresponding to the maximum value Tₑₘₐₓ of the error cycle provided from the error cycle maximum value retrieving portion 4.

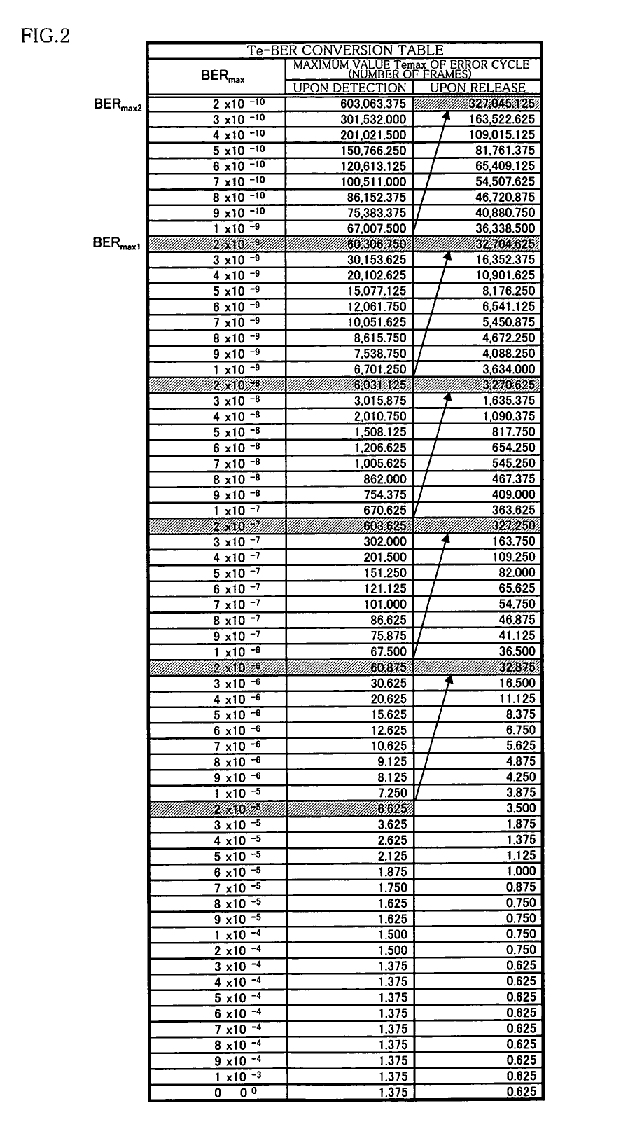

FIG. 2 shows an example of the conversion table 5 mentioned above. For each of the data of the error cycle maximum value Tₑₘₐₓ, the BER on the left side thereof indicates the estimated error rate value. For example, the maximum value Tₑₘₐₓ=60,306.750 shown by hatching corresponds to BERₘₐₓ₁=2×10 ⁻⁹. As will be described later, the reason why the maximum values Tₑₘₐₓ upon alarm detection and upon alarm release are different is that a hysteresis is provided therebetween. In this example, the estimated error rate upon alarm release (BERₘₐₓ₂ for BERₘₐₓ₁) is set to one tenth of the estimated error rate upon error detection (e.g. BERₘₐₓ₁).

A calculation example for having the BER from the error cycle will now be described as follows:

The probability that a parity error of “r” bits within a frame occurs is given by the following equation:

P(r)=_{N}Cᵣ×((1−q)^{(N-r)}×q^{(r)}) Eq. (1)

where,

N: Number of bits to be calculated for 1 parity bit

q: Line error rate

When a probability including the event probability of a plurality of bits is obtained, a probability of detecting a parity error within 1 parity frame assumes ΣP(r). It is to be noted that the summation can be calculated by regarding that the simultaneous occurrence of the number of bits equal to or more than “r” is stochastically negligible.

Also, it is required that a probability of SF/SD detection therefrom is calculated to carefully obtain a probability of a false detection and false release at a rate differing by one digit.

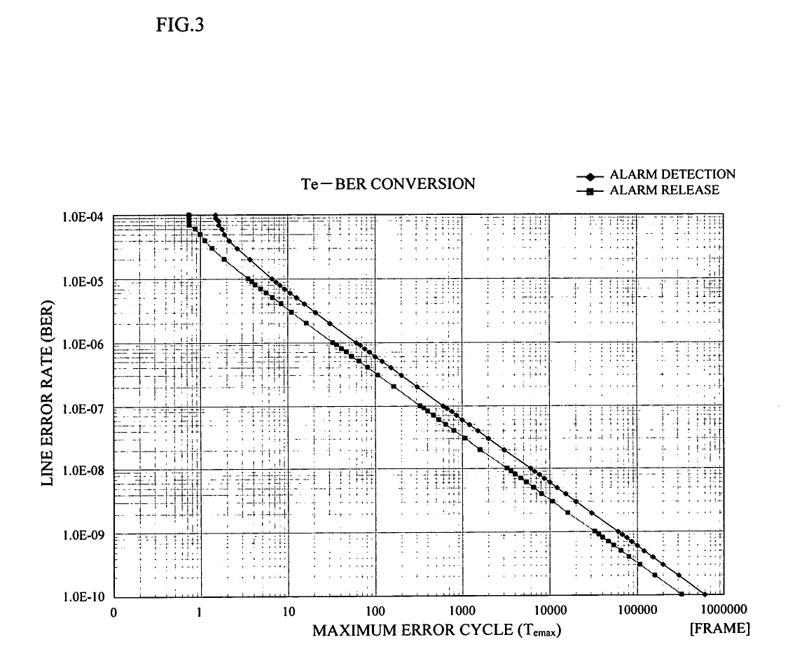

From this calculation result, the number of collected frames that meets a detecting (releasing) condition is derived to prepare the table shown in FIG. 2. FIG. 3 shows the table of FIG. 2 converted into graph form on a double logarithmic graph and shows a linearity as a whole.

As described above, the SF/SD detecting portion 6 having received the estimated maximum error cycle BERₘₐₓ obtained by the conversion table 5 compares the estimated maximum error cycle BERₘₐₓ with the preset alarm detecting threshold Th_{d} and the alarm releasing threshold Thᵣ to determine the relationship therebetween. A comparison example in this case is shown in the following Table 1.

TABLE 1

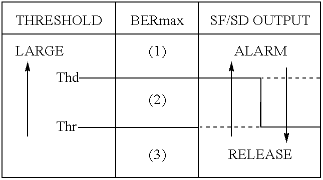

Namely, as shown in Table 1, when the output BERₘₐₓ from the conversion table 5 gradually increases from a value lower than the threshold Thᵣ, namely when the error state of the input data worsens, an alarm signal is not generated from the SF/SD detecting portion 6 in states (2) and (3) where BERₘₐₓ<alarm detecting threshold Th_{d}, but the SF/SD detecting portion 6 outputs the alarm ALM in a state (1) where BERₘₐₓ≦alarm detecting threshold Th_{d}.

Thereafter, when the error state of the input data is improved and the output BERₘₐₓ of the conversion table 5 gradually decreases, the alarm detected state continues in the states (1) and (2) where the BERₘₐₓ is equal to or less than the alarm releasing threshold Thᵣ, but the SF/SD detecting portion 6 releases the alarm on the supposition that the BERₘₐₓ enters the state (3) at the time when the BERₘₐₓ becomes smaller than the alarm releasing threshold Thᵣ.

Thus, without using the timer, the alarm signal is generated when the BER of the input data worsens, and the alarm is released when the BER returns to a favorable state.

On the other hand, the alarm release of the SF/SD detecting portion 6 is also performed by the error-free detecting portion 7. This is because in the alarm releasing operation, the error cycle measurement is disabled upon entering an error-free state, that is a state where an error does not occur in the input data. Therefore, the alarm is released when it becomes error-free in a predetermined time period.

Accordingly, the error-free detecting portion 7 is provided with an alarm ALM from the SF/SD detecting portion 6, so that the error-free detecting portion 7 is activated by the alarm signal ALM.

Also, while the cycle monitoring reference clock CLK is constantly provided, when the error cycle Tₑ outputted from the error cycle detecting portion 2 stays flat for a time period of an error cycle threshold T_{eThr} corresponding to the above-mentioned alarm releasing threshold Thᵣ (namely when a parity error is not included in the input data and the error cycle Tₑ is held due to an error pulse P_{E} from the parity check portion 1 being not generated), the error-free detecting portion 7 releases the alarm state of the SF/SD detecting portion 6 by generating an error-free signal E_{f} by regarding that it is an error-free state where the alarm state should be released. Also, the error cycle memory 3 is initialized by the error-free signal E_{f}. It is to be noted that the error cycle threshold T_{eThr} need not necessarily correspond to the alarm releasing threshold Thᵣ.

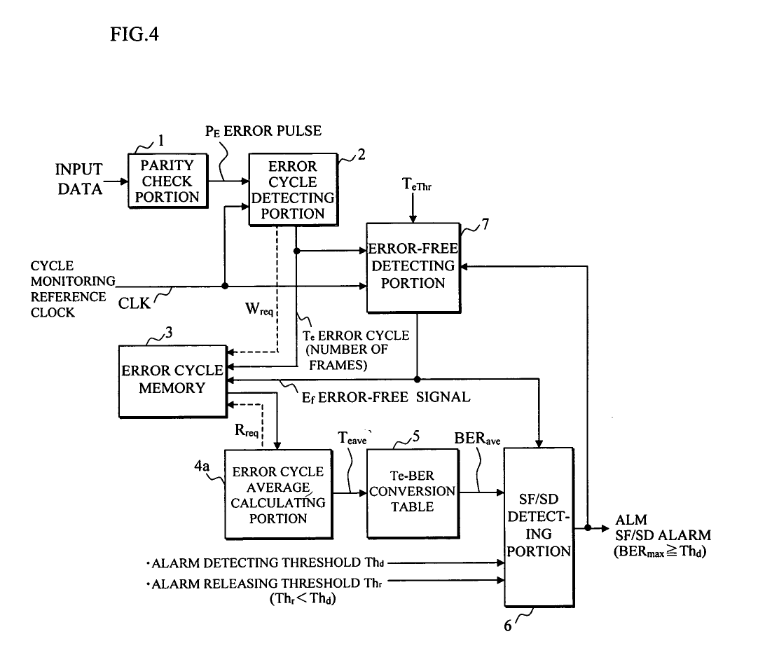

### Embodiment [2]: FIG. 4

While the maximum error cycle Tₑₘₐₓ is obtained by using the error cycle maximum value retrieving portion 4 in the above-mentioned embodiment [1], this embodiment [2] is different in that an error cycle average calculating portion 4a calculating an average Tₑₐᵥₑ substituted for the maximum value Tₑₘₐₓ of the error cycles is used. Therefore, the output of the conversion table 5 assumes an estimated error rate BERₐᵥₑ corresponding thereto.

Namely, while the above-mentioned embodiment [1] is premised on scattered errors, this embodiment [2] adopts an arithmetic average, thereby enabling the estimation of the BER by using smoothed error cycles where influence of distribution is reduced even when a burst error occurs.

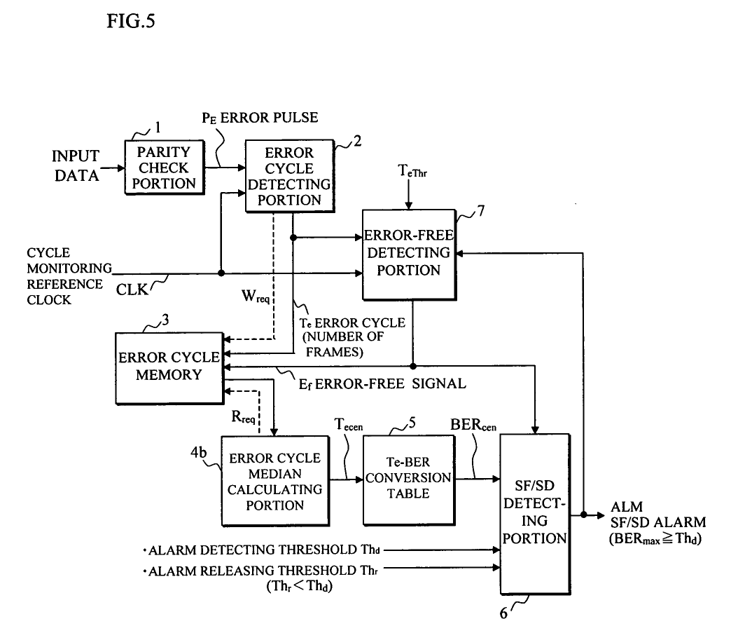

### Embodiment [3]: FIG. 5

This embodiment is different from the above-mentioned embodiment [1] in that an error cycle median calculating portion 4b for calculating a median T_{ecen} of the error cycles is substituted for the error cycle maximum value retrieving portion 4. Therefore, the output of the conversion table 5 assumes an estimated error rate BER_{cen} corresponding thereto.

Namely, while the above-mentioned embodiment [1] is premised on the scattered error, this embodiment enables an estimation of an error rate reducing the influence even in the case where a burst error occurs by calculating the median of the error cycle.

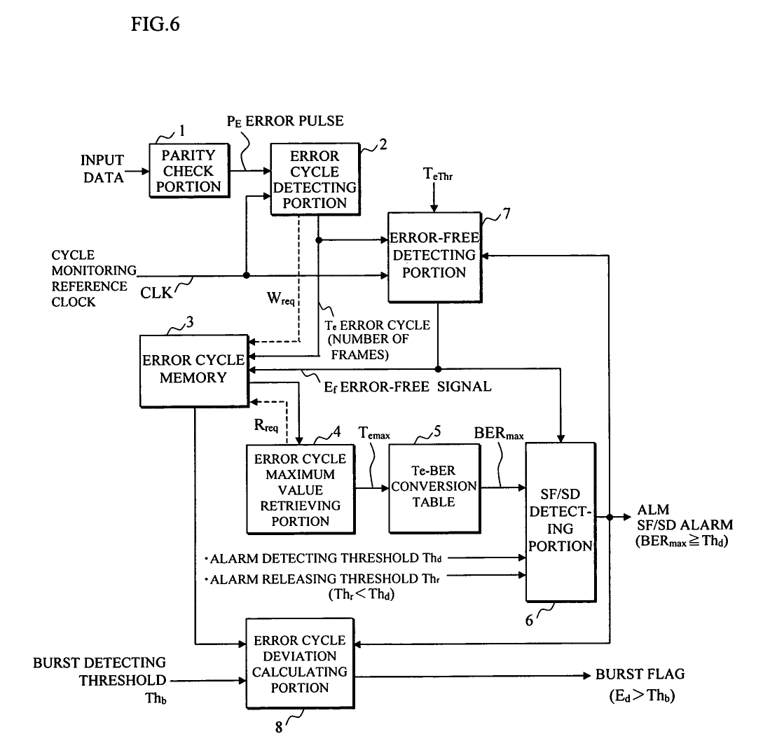

### Embodiment [4]: FIG. 6

This embodiment is different from the above-mentioned embodiment [1] in that an error cycle deviation calculating portion 8 is added.

Namely, the error cycle deviation calculating portion 8 constantly obtains the deviation of the error cycles at the time of error detection with the read request R_{req} from the error cycle maximum value retrieving portion 4 for the error cycle data stored in the error cycle memory 3. When the alarm is generated from the SF/SD detecting portion 6, the error cycle deviation calculating portion 8 determines whether or not the deviation value at this time exceeds a burst detecting threshold Th_{b} and generates a burst flag when deviation value exceeds the burst detecting threshold Th_{b}.

Thus, it is made possible to determine whether or not the current alarm detected state is due to a burst state.

It is to be noted that this is an operation performed only when a burst error is detected, so that this operation is not activated upon alarm release.

The present invention is not limited by the above-mentioned embodiments, and it is obvious that various modifications may be made by one skilled in the art based on the recitation of the claims.

What is claimed is:

1. A BER monitoring circuit comprising:
a first means detecting error cycles of input data;
a second means detecting a maximum value from among the error cycles;
a third means converting the maximum value into a corresponding estimated error rate; and
a fourth means generating an alarm when the estimated error rate exceeds an alarm detecting threshold.

2. The BER monitoring circuit as claimed in claim 1, wherein the fourth means includes means releasing the alarm when the estimated error rate assumes equal to or less than an alarm releasing threshold.

3. The BER monitoring circuit as claimed in claim 2, further comprising a fifth means being activated when the alarm is generated and releasing the alarm when a time period for which the error cycles stay flat exceeds a cycle corresponding to the alarm releasing threshold.

4. The BER monitoring circuit as claimed in claim 1, further comprising a sixth means constantly calculating a deviation of the error cycles and generating a burst flag when the deviation upon generation of the alarm exceeds a burst detecting threshold.

5. The BER monitoring circuit as claimed in claim 2, further comprising a sixth means constantly calculating a deviation of the error cycles and generating a burst flag when the deviation upon generation of the alarm exceeds a burst detecting threshold.

6. The BER monitoring circuit as claimed in claim 3, further comprising a sixth means constantly calculating a deviation of the error cycles and generating a burst flag when the deviation upon generation of the alarm exceeds a burst detecting threshold.

7. A BER monitoring circuit comprising:
a first means detecting error cycles of input data;
a second means detecting an average of the error cycles;
a third means converting the average into a corresponding estimated error rate; and
a fourth means generating an alarm when the estimated error rate exceeds an alarm detecting threshold.

8. The BER monitoring circuit as claimed in claim 7, wherein the fourth means includes means releasing the alarm when the estimated error rate assumes equal to or less than an alarm releasing threshold.

9. The BER monitoring circuit as claimed in claim 8, further comprising a fifth means being activated when the alarm is generated and releasing the alarm when a time period for which the error cycles stay flat exceeds a cycle corresponding to the alarm releasing threshold.

10. The BER monitoring circuit as claimed in claim 7, further comprising a sixth means constantly calculating a deviation of the error cycles and generating a burst flag when the deviation upon generation of the alarm exceeds a burst detecting threshold.

11. The BER monitoring circuit as claimed in claim 8, further comprising a sixth means constantly calculating a deviation of the error cycles and generating a burst flag when the deviation upon generation of the alarm exceeds a burst detecting threshold.

12. The BER monitoring circuit as claimed in claim 9, further comprising a sixth means constantly calculating a deviation of the error cycles and generating a burst flag when the deviation upon generation of the alarm exceeds a burst detecting threshold.

13. A BER monitoring circuit comprising:
a first means detecting error cycles of input data;
a second means detecting a median of the error cycles;
a third means converting the median into a corresponding estimated error rate; and
a fourth means generating an alarm when the estimated error rate exceeds an alarm detecting threshold.

14. The BER monitoring circuit as claimed in claim 13, wherein the fourth means includes means releasing the alarm when the estimated error rate assumes equal to or less than an alarm releasing threshold.

15. The BER monitoring circuit as claimed in claim 14, further comprising a fifth means being activated when the alarm is generated and releasing the alarm when a time period for which the error cycles stay flat exceeds a cycle corresponding to the alarm releasing threshold.

16. The BER monitoring circuit as claimed in claim 13, further comprising a sixth means constantly calculating a deviation of the error cycles and generating a burst flag when the deviation upon generation of the alarm exceeds a burst detecting threshold.

17. The BER monitoring circuit as claimed in claim 14, further comprising a sixth means constantly calculating a deviation of the error cycles and generating a burst flag when the deviation upon generation of the alarm exceeds a burst detecting threshold.

18. The BER monitoring circuit as claimed in claim 15, further comprising a sixth means constantly calculating a deviation of the error cycles and generating a burst flag when the deviation upon generation of the alarm exceeds a burst detecting threshold.

19. A BER monitoring circuit comprising:
a first detector detecting error cycles of input data;
a second detector detecting at least one of a maximum value, an average value, and a median value from among the error cycles;
a converter converting the value into a corresponding estimated error rate; and
a generator generating an alarm when the estimated error rate exceeds an alarm detecting threshold.

20. A BER monitoring method comprising:
a first step of detecting error cycles of input data;
a second step of detecting at least one of a maximum value, an average value, and a median value from among the error cycles;
a third step of converting the value into a corresponding estimated error rate; and
a fourth step of generating an alarm when the estimated error rate exceeds an alarm detecting threshold.
